(19) United States
(12) Patent Application Publication
(10) Pub. No.: US 2023/0120985 A1
(43) Pub. Date: Apr. 20, 2023

(54) METHOD FOR TRAINING FACE RECOGNITION MODEL

(71) Applicant: BEIJING BAIDU NETCOM SCIENCE TECHNOLOGY CO., LTD., Beijing (CN)

(72) Inventors: Yanwen Fan, Beijing (CN); Xiyu Yu, Beijing (CN); Gang Zhang, Beijing (CN); Jingtuo Liu, Beijing (CN); Haifeng Wang, Beijing (CN); Errui Ding, Beijing (CN); Junyu Han, Beijing (CN)

(73) Assignee: BEIJING BAIDU NETCOM SCIENCE TECHNOLOGY CO., LTD., Beijing (CN)

(21) Appl. No.: 18/083,313

(22) Filed: Dec. 16, 2022

Related U.S. Application Data
(63) Continuation of application No. PCT/CN2020/117009, filed on Sep. 23, 2020.

(30) Foreign Application Priority Data
Jun. 19, 2020 (CN) 202010564107.4

(51) Int. Cl. G06V 10/774; G06V 40/16; G06V 10/26; G06V 10/77

(52) U.S. Cl. CPC G06V 10/774; G06V 40/162; G06V 40/171; G06V 10/267; G06V 10/273; G06V 10/7715

(57) ABSTRACT

A method for training a face recognition model includes: acquiring a plurality of first training images being uncovered face images, and acquiring a plurality of covering object images; generating a plurality of second training images by separately fusing the plurality of covering object images with the uncovered face images; and training the face recognition model by inputting the plurality of first training images and the plurality of second training images into the face recognition model.

### CROSS-REFERENCE TO RELATED APPLICATIONS

This application is a continuation of International Patent Application No. PCT/CN2020/117009 filed on Sep. 23, 2020, which is based upon and claims priority to Chinese Patent Application No. 202010564107.4, filed on Jun. 19, 2020, titled “METHOD AND DEVICE FOR TRAINING FACE RECOGNITION MODEL” filed by BEIJING BAIDU NETCOM SCIENCE AND TECHNOLOGY CO., LTD., the entire content of which is incorporated herein by reference.

### FIELD

The present disclosure relates to the fields of artificial intelligence, deep learning and computer vision technologies, and in particular to a method for training a face recognition model.

### BACKGROUND

At present, the face recognition technology has been widely used in various applications, such as video surveillance, security and protection, and financial payment. In daily life, user's face may be covered by a mouth-muffle, a scarf or other layers. In this case, the face recognition is difficult to be applied since a lot of facial features are missing due to the covering.

In the existing face recognition technology, an accurate face recognition result is obtained according to collected face recognition image(s).

### SUMMARY

In embodiments of a first aspect of the present disclosure, a method for training a face recognition model is provided. The method includes: acquiring a plurality of first training images being uncovered face images, and acquiring a plurality of covering object images; generating a plurality of second training images by separately fusing the plurality of covering object images with the uncovered face images; and training the face recognition model by inputting the plurality of first training images and the plurality of second training images into the face recognition model.

In embodiments of a second aspect of the present disclosure, a face recognition method is provided. The face recognition method includes: acquiring a face image to be recognized; and inputting the face image to be recognized into a face recognition model to acquire a recognition result output by the face recognition model. The face recognition model is trained by the method for training the face recognition model according to the embodiments of the first aspect.

In embodiments of a third aspect of the present disclosure, an electronic device is provided. The electronic device includes: at least one processor; and a memory communicatively connected with the at least one processor. The memory stores instructions executable by the at least one processor, and when the instructions are executed by the at least one processor, the at least one processor is configured to implement the method for training the face recognition model according to the embodiments of the first aspect.

### BRIEF DESCRIPTION OF THE DRAWINGS

The drawings are used to better understand the solution and do not constitute a limitation to the present disclosure, in which:

FIG. 1 is a flowchart of a method for training a face recognition model according to an embodiment of the present disclosure.

FIG. 2 is a flowchart of acquiring a covering object image according to an embodiment of the present disclosure.

FIG. 3 is a flowchart of generating a second training image according to an embodiment of the present disclosure.

FIG. 4 is a block diagram of an apparatus for training a face recognition model according to an embodiment of the present disclosure.

FIG. 5 is a block diagram of an electronic device configured to implement a method for training a face recognition model according to an embodiment of the present disclosure.

### DETAILED DESCRIPTION

The following describes the exemplary embodiments of the present disclosure with reference to the accompanying drawings, which includes various details of the embodiments of the present disclosure to facilitate understanding, which shall be considered merely exemplary. Therefore, those of ordinary skill in the art should recognize that various changes and modifications can be made to the embodiments described herein without departing from the scope and spirit of the present disclosure. For clarity and conciseness, descriptions of well-known functions and structures are omitted in the following description.

Some face recognition models in the related art do not have the ability to recognize a face when it is covered, or have a low recognition rate for the covered face, and thus they cannot satisfy the applications of recognizing the covered face. Some models have the ability to recognize a covered face, but in order to improve a recognition rate for covering object(s), they sacrifice the accuracy of recognizing an uncovered standard face.

To solve the above-mentioned technical problem that the existing face recognition models cannot accurately recognize both the covered face and the uncovered face, the present disclosure provides a method for training a face recognition model. The face recognition model is trained with images of covered face(s) and uncovered face(s), and the trained model can accurately identify both the uncovered face and the covered face, solving the problems that the existing face recognition model has a low recognition accuracy for a face image in which the face is partially covered with an object, or is even impossible to recognize the face image in which the face is partially covered with an object.

The following describes a method and an apparatus for training a face recognition model, an electronic device, and a storage medium in the embodiments of the present disclosure with reference to the accompanying drawings.

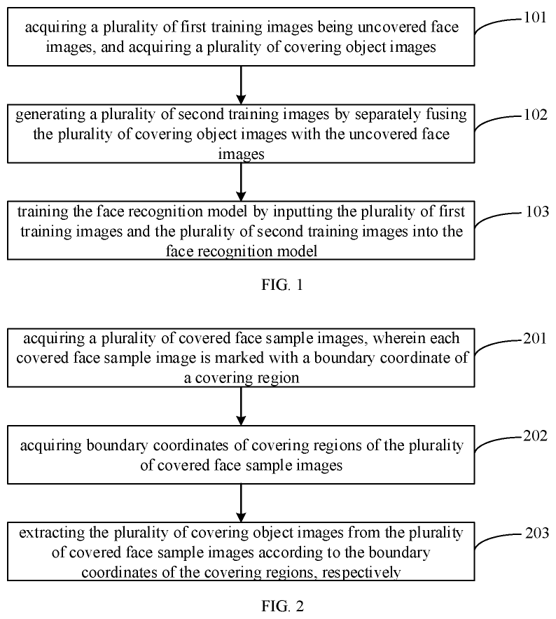

FIG. 1 is a flowchart of a method for training a face recognition model according to an embodiment of the present disclosure.

In the embodiments of the present disclosure, an apparatus for training a face recognition model is configured to perform the method for training the face recognition model, such an apparatus may be configured in an electronic device to allow the electronic device to have the function for training the face recognition model.

The electronic device may be a personal computer (PC), a cloud device, or a mobile device. The mobile device may be a hardware device with various operating systems, display/touch screen, such as a mobile phone, a tablet computer, a personal digital assistant, a wearable device, and a vehicle-mounted device.

In an embodiment, the method for training the face recognition model may also be executed at a server side. The server may be a cloud server, and the method for training the face recognition model may be executed on the cloud.

As shown in FIG. 1, the method for synthetizing a speech includes the following operations.

At block 101, a plurality of first training images being uncovered face images is acquired, and a plurality of covering object images is acquired.

The first training image is the uncovered face image, that is, a standard face image in which a face in the image is not covered by any covering object.

In an embodiment, the first training image may be an image collected by a terminal device, or an uncovered face image input through an electronic device, or an uncovered face image downloaded from a server, which is not limited herein.

For example, the first training image may be an uncovered face image collected by a camera or a terminal at an entrance of a community, or an uncovered face image collected by a terminal device for example when a user perform a face-scanning payment, or an uncovered face image collected by an attendance system of a company or a school.

The covering object in the present disclosure may be an item that at least partially covers a human face, such as a mouth-muffle, a veil, a mask, and a scarf. The covering object image may be an image corresponding to the covering object, for example, images of various masks.

In an embodiment, the covering object image may be acquired from an independently-placed covering object, and may be collected by a terminal device, or acquired, by the terminal device, from image segmentation performed on a face image in which the face is partially covered with the covering object, which is not limited herein.

It should be noted that, different covering objects may be photographed and the covering object images of different types are collected. For example, the covering object may be a mask, images of different types of masks can be collected as the plurality of covering object images.

At block 102, a plurality of second training images is generated by separately fusing the plurality of covering object images with the uncovered face images.

The second training image refers to an image of a face that is partially covered by a covering object, for example, an image of a face covered by a gauze mask or a full face mask. In order to facilitate the distinction from the uncovered face image, the covered face image used for training the face recognition model is referred as the second training image in the present disclosure. Such a kind of images may be referred as other terms, which are not limited herein.

In the embodiment of the present disclosure, after the uncovered face images and the plurality of covering object images are acquired, the plurality of covering object images may be separately fused with a specified position of each uncovered face image to generate the plurality of second training images.

In an embodiment, fusion is performed by mapping the covering object images to a specified position of an uncovered image to acquire second training images, respectively. For example, the covering object image is a gauze mask image, and multiple covering object images can be mapped to a mask-wearing position of the uncovered face image, to cover parts such as nose, mouth, and chin of the face. Through the image fusion, the second training image is acquired.

At block 103, the face recognition model is trained by inputting the plurality of first training images and the plurality of second training images into the face recognition model.

The face recognition model may be an existing model capable of accurately identifying or recognizing an uncovered face image collected.

In the embodiment of the present disclosure, after the first training image and the second training image are acquired, the first training image and the second training image may be input into the face recognition model, and parameter(s) of the face recognition model is adjusted, the face recognition model with the parameter adjustment is further trained until the trained face recognition model can accurately identify/recognize both the covered face image and the uncovered face image.

It should be noted that, in order to enable the trained face recognition model to accurately recognize uncovered faces and partially covered faces, a plurality of first training images and a plurality of second training images may be input in the face recognition model. In an embodiment, the number of the first training images and the number of the second training images input to the face recognition model are of a same order of magnitude. The number of the first training images may be the same as the number of the second training images. For example, 1000 first training images are input into the face recognition model, and 1000 second training images are input into the face recognition model. In another embodiment, the number of the second training images is greater than the number of the first training images.

In an embodiment of the present disclosure, the face recognition model may include a feature extraction network and a recognition module. After the first training image and the second training image are input into the face recognition model, the feature extraction network is configured to extract a feature from an input image according to a preset feature extraction weight to acquire a feature map of the face image. The extracted face map is compared with a feature map pre-stored in a model library, and the parameter(s) of the face recognition model may be adjusted according to the comparison result. In this case, the face recognition model is able to accurately recognize the uncovered face and the partially covered face.

It can be understood that in normal situations, nose, mouth, and chin of user's face are covered. In order to improve the recognition rate for the covered image and solve the problem that the accuracy of the face recognition for the uncovered face image decreases after supporting the face recognition for the covered face image, the existing face recognition model uniformly extracts feature information of every region (such as eyes, mouth, and nose) in the face image, and compares these features with the pre-stored ones. However, after a part (such as mouth and nose) of the face is covered, the corresponding feature of this part cannot be extracted, resulting in a great loss of the feature information. In the present disclosure, the feature extraction weight may be preset, and the feature extraction may be performed on the face image according to the preset feature extraction weight. In this way, deep learning in the features in the common region in the uncovered face image and the covered face image is improved. In an embodiment, the feature extraction for the eye region is strengthened, and a feature importance for the covered part of the face is weaken. In this way, for the uncovered face image, although the feature extraction ability of the model for the lower half of the face is weakened, there is little impact on the recognition effect since the importance of the lower half is low.

In the method for training the face recognition model according to the embodiments of the present disclosure, the face recognition model is trained by using the uncovered face image and the plurality of second training images (acquired by separately fusing the covering objects with the uncovered face image). The trained face recognition model can accurately identify both the uncovered face image and the covered face image, which solves the problem of low accuracy or even the inability in recognizing the face image in which a part of the face is covered by an object in the existing face recognition models.

On the basis of the above embodiments, in order to better match the acquired covering object image to an image region for the covering object in the face image after the face in the face image is covered with the covering object, the covering object images can be extracted from covered face images. Such a process will be described in detail below with reference to FIG. 2, showing a sub-flowchart of acquiring a covering object image according to an embodiment of the present disclosure.

As shown in FIG. 2, the operation in block 101 may further include the following operations.

At block 201, a plurality of covered face sample images is acquired, each covered face sample image is marked with a boundary coordinate of a covering region where at least a part of a face of the covered face sample image is covered by a covering object.

The covered face sample image may be an image of a face that is at least partially covered by an object. For every covered face sample image, the boundary coordinate of the covering region is marked to indicate a covering range. The covering region refers to a region corresponding to the covering object in a face image.

In the embodiment of the present disclosure, the covered face sample image may be an image collected by a terminal device, or input by an electronic device, or downloaded from a server, which is not limited herein.

At block 202, boundary coordinates of covering regions of the plurality of covered face sample image are acquired.

In the present disclosure, since the boundary coordinates of the covering regions are marked in the covered face sample images, after acquiring the plurality of covered face sample images, the boundary coordinates corresponding to the covering regions in the covered face sample images can be acquired, respectively.

For example, the covering object is a gauze mask, a boundary coordinate corresponding to a region of the gauze mask worn on a face in a covered face sample image is pre-marked, and thus a boundary coordinate of a corresponding gauze mask region in the covered face sample image is acquired.

At block 203, the plurality of covering object images is extracted from the plurality of covered face sample images according to the boundary coordinates of the covering regions, respectively.

The covering object image may be an image corresponding to a covering object, for example, various types of masks.

In the embodiment of the present disclosure, after determining the boundary coordinate of the corresponding covering region in each covered face sample image, the covering object images may be extracted from the covered face sample images according to the boundary coordinates of the covering regions, respectively.

In an embodiment, after determining the boundary coordinate of the corresponding covering region in each covered face sample image, the covering region may be separated from the covered face sample image by a segmentation process according to the corresponding boundary coordinate, to acquire the image of the corresponding covering object.

In the embodiments of the present disclosure, by marking the boundary coordinates of the covering regions in the covered face sample images, the covering object images can be extracted from the covered face sample images. In this way, the acquired covering object image is well matched with an image region corresponding to the covering object in the face image after the face in the image is covered by the covering object, thus improving the ability of the trained face recognition model for recognizing the face that is partially covered in the face image.

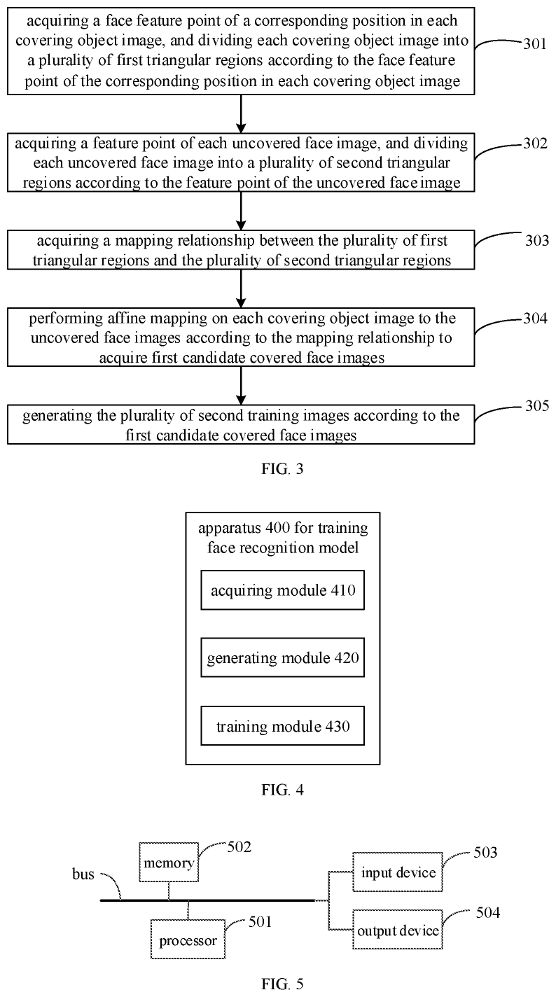

On the basis of the above embodiments, in order to further improve the recognition ability of the trained face recognition model for recognizing both the uncovered face image and the covered face image, a more realistic covered face image (i.e., the second training image) may be generated. Such a process will be described in detail below with reference to FIG. 3, showing a sub-flowchart of generating a plurality of second training images according to an embodiment of the present disclosure.

As shown in FIG. 3, the operation in block 102 may further include the following operations.

At block 301, a face feature point of a corresponding position in each covering object image is acquired, and each covering object image is divided into a plurality of first triangular regions according to the face feature point of the corresponding position of each covering object image. The corresponding position refers to a position where a covering object of the covering object image is to be positioned on a face.

In an embodiment, each covered face sample image is marked with a face feature point, and after the plurality of covering object images are acquired, the face feature point of the corresponding position of the covering object image can be acquired. The corresponding position refers to the position where the covering object of the covering object image is to be positioned on a face. For example, the covering object may be a face mask, and normally it is to be worn on a face to cover nose and mouth and thus has feature points of nose and mouth. It can be understood that, the nose or mouse may include one or more feature points. Further, each covering object image is subjected to triangulation according to the face feature point of the corresponding position of the covering object image, and thus each covering object image is divided into the plurality of first triangular regions.

Triangulation refers to a process that a plane with some points is divided into triangles, and no triangle's points are inside a circumcircle of any other triangles. If there is feature point in the circumcircle of another triangle, a new combination of triangles is searched until all the feature points in the covering object image satisfy the condition, and finally acquiring the plurality of triangles.

In the embodiments of the present disclosure, in order to distinguishing from the triangular regions obtained by triangulating the uncovered face image, the triangular regions acquired by triangulating the covering object image is referred as a first triangular region.

For example, after acquiring the feature points of the covering object image, the covering object image may be divided into 51 triangular regions according to the feature points of the covering object image.

At block 302, a feature point of each uncovered face image is acquired, and each uncovered face image is divided into a plurality of second triangular regions according to the feature point of the uncovered face image.

In the embodiments of the present disclosure, after the uncovered face image is acquired, feature point extraction is performed on the uncovered face image to acquire feature point(s) of the uncovered face image. In an embodiment, the uncovered face image may be input into a trained feature point extraction model to determine the feature point(s) of the uncovered face image from output of the model. The feature point(s) of the uncovered face image may include a feature point such as mouth, nose, eyes and eyebrows.

In the embodiments of the present disclosure, after the feature point of the uncovered face image is acquired, the uncovered face image may be triangulated according to the feature point of the uncovered face image to divide the uncovered face image into a plurality of second triangular regions.

At block 303, a mapping relationship between the plurality of first triangular regions and the plurality of second triangular regions is acquired.

In the embodiments of the present disclosure, the covering object image and the uncovered face image have common feature point(s), and the mapping relationship between the plurality of first triangular regions and the plurality of second triangular regions can be established according to position(s) corresponding to the same feature point(s) existing in the covering object image and the uncovered face image.

At block 304, affine mapping is performed on each covering object image to the uncovered face images according to the mapping relationship to acquire first candidate covered face images.

In the embodiments of the present disclosure, according to the mapping relationship between the plurality of first triangular regions in the covering object image and the plurality of second triangular regions in the uncovered face image, the covering object image can be mapped to the uncovered face image to acquire the first candidate covered face image.

It will be appreciated that the covering object image may be mapped onto the uncovered face image to partially cover the face in the uncovered face image, such that the uncovered face image is converted into the covered face image.

For example, the covering object image is a face mask image, the face mask image is mapped to an uncovered face image (i.e., a face in this image is not covered by the face mask), and thus the covered face image (in which the face is covered by the face mask) can be obtained.

At block 305, the plurality of second training images is generated according to the first candidate covered face images.

In an embodiment, the covering object image is mapped to the uncovered face image, and the acquired first candidate covered face image is a standard covered face image. In this case, the first candidate covered face image can be taken as the second training image, and the face recognition model is trained according to the generated second training image. In this way, the standard covered face image in which the face is covered by the covering object can be obtained, and after training the face recognition model, the recognition accuracy of the model can be improved.

In another embodiment, the covering object image is mapped to the uncovered face image to acquire the first candidate covered face image, in which the covering object may be worn abnormally. For example, a user may wear a face mask at a relatively low position, and the nose of the user is not covered. In this case, the covering object image extracted according to the boundary coordinate of the covering region will contain a nose portion, the nose portion will be mapped to the uncovered face image when the covering object image is mapped to the uncovered face image, and the generated first candidate covered face image will include a nose portion. In order to acquire a standard covered face image, the boundary coordinate of the covering region may be mapped to the coordinate of the uncovered face image to acquire the coordinate of the second candidate covered face image. According to the coordinate of the second candidate covered face image, the uncovered region in the first candidate covered face image is removed to acquire a mapped covering object image. The mapped covering object image and the uncovered face image are fused to acquire the second training image.

In order to improve the quality of the generated second training image, when the mapped covering object image is fused with the uncovered face image, the fused boundary may be smoothed to acquire the second training image of a higher quality.

In an embodiment, the face recognition model in the above embodiments may include a feature extraction network and a recognition module.

The feature extraction network is configured to acquire a feature map of a face image according to a preset feature extraction weight.

It can be understood that the face recognition model in the related art will relatively uniformly extract feature information from different regions (such as eyes, mouth, and nose) of a face, and the feature information of these features is used for the comparison. However, after wearing e.g., a face mask, the position of mouth and nose is covered, the corresponding features cannot be extracted, and the loss of feature information is large. In order to improve the recognition accuracy of the face recognition model and ensure that the model is able to recognize both the uncovered face image and the partially covered face image, the feature extraction of eye region can be strengthened. That is, a higher extraction weight can be set on the eye region. Accordingly, the feature map of the face image is extracted according to the preset feature extraction weight.

The recognition module is configured to acquire a comparison result by comparing a feature map of the face image with a preset feature map stored in a model library, and to determine a face recognition result according to the comparison result.

It can be understood that the face recognition model includes a model library including feature map(s) corresponding to uncovered face image(s), and a model library including feature map(s) corresponding to covered face image(s). After a feature map of one face image is extracted by the feature extraction network, the feature map of the face image can be compared with the preset feature map stored in the model library to acquire a comparison result, and a face recognition result can be determined according to the comparison result.

Based on the method for training the face recognition model according to the embodiments of the present disclosure, a face recognition method is further provided. The face recognition method includes: acquiring a face image to be recognized; and inputting the face image to be recognized into a face recognition model to acquire a recognition result output by the trained face recognition model.

It should be noted that the above described details for the embodiments of the method for training the face recognition model are also applicable to the face recognition method, which will not be elaborated here.

In order to realize the above embodiments, the present disclosure provides in embodiments an apparatus for training a face recognition model.

FIG. 4 is a block diagram of an apparatus for training a face recognition model according to an embodiment of the present disclosure.

As shown in FIG. 4, the apparatus 400 for training the face recognition model includes an acquiring module 410, a generating module 420 and a training module 430. The acquiring module 410 is configured to acquire a plurality of first training images being uncovered face images, and acquire a plurality of covering object images. The generating module 420 is configured to generate a plurality of second training images by separately fusing the plurality of covering object images with the uncovered face images. The training module 430 is configured to train the face recognition model by inputting the plurality of first training images and the plurality of second training images into the face recognition model.

In an embodiment, the acquiring module 410 further includes: a first acquiring unit configured to acquire a plurality of covered face sample images, in which each covered face sample image is marked with a boundary coordinate of a covering region where at least a part of a face of the covered face sample image is covered by a covering object; a second acquiring unit configured to acquire boundary coordinates of covering regions of the plurality of covered face sample images; and an extracting unit configured to extract the plurality of covering object images from the plurality of covered face sample images according to the boundary coordinates of the covering regions, respectively.

In an embodiment, each covered face sample image is further marked with a face feature point, and the generating module 420 includes: a first dividing unit configured to acquire a face feature point in a corresponding position of each covering object image, in which the corresponding position refers to a position where a covering object of the covering object image is to be positioned on a face, and to divide each covering object image into a plurality of first triangular regions according to the face feature point of the corresponding position in each covering object image; a second dividing unit configured to acquire a feature point of each uncovered face image, and divide each uncovered face image into a plurality of second triangular regions according to the feature point of the uncovered face image; a third acquiring unit configured to acquire a mapping relationship between the plurality of first triangular regions and the plurality of second triangular regions; a mapping unit configured to perform affine mapping on each covering object image to the uncovered face images according to the mapping relationship to acquire first candidate covered face images; and a generating unit configured to generate the plurality of second training images according to the first candidate covered face images.

In an embodiment, the generating unit is further configured to: perform affine mapping on the boundary coordinates of the covering regions to a coordinate of the uncovered face image to acquire coordinates of second candidate covered face images; remove, according to the coordinates of the second candidate covered face images, an uncovered region from the first candidate covered face images to acquire mapped covering object images; and fuse the mapped covering object image with the uncovered face image to acquire the plurality of second training images.

In an embodiment, the face recognition model includes: a feature extraction network configured to acquire a feature map of a face image according to a preset feature extraction weight; and a recognition module configured to acquire a comparison result by comparing the feature map of the face image with a preset feature map stored in a model library, and to determine a face recognition result according to the comparison result.

In an embodiment, the number of the plurality of first training images and the number of the plurality of second training images input to the face recognition model are of a same order of magnitude.

It should be noted that the above described details for the embodiments of the method for training the face recognition model are also applicable to the apparatus for training the face recognition model of the embodiments, which will not be elaborated here.

With the apparatus for training the face recognition model according to the embodiments of the present disclosure, the face recognition model is trained by using the plurality of uncovered face images and the plurality of second training images acquired by fusing the plurality of covering objects into each uncovered face image. The trained face recognition model can accurately identify both uncovered face images and covered face images, which solves the technical problem of the low accuracy or even the inability in recognizing face images in which the face of the images is partially covered by an object in the existing face recognition models.

In order to implement the above-mentioned embodiments, the present disclosure provides an electronic device, including: at least one processor; and a memory communicatively connected with the at least one processor. The memory stores instructions executable by the at least one processor, and when the instructions are executed by the at least one processor, the at least one processor is configured to implement the method for training the face recognition model according to the above embodiments.

In order to implement the above embodiments, the present disclosure provides a non-transitory computer-readable storage medium having stored computer instructions. The computer instructions are executed to cause a computer to implement the method for training the face recognition model according to the above embodiments.

In the embodiments of the present disclosure, the present disclosure further provides an electronic device and a readable storage medium.

FIG. 5 is a block diagram of an electronic device for performing a method for training a face recognition model according to an embodiment of the present disclosure. Electronic devices are intended to represent various forms of digital computers, such as laptop computers, desktop computers, workstations, personal digital assistants, servers, blade servers, mainframe computers, and other suitable computers. Electronic devices may also represent various forms of mobile devices, such as personal digital assistants, cellular telephones, smart phones, wearable devices, and other computing devices. The components illustrated herein, their connections and relationships, and their functions are merely examples and are not intended to limit the implementations of the present disclosure described and/or claimed herein.

As shown in FIG. 5, the electronic device includes: one or more processors 501, a memory 502, and interfaces (including a high speed interface and a low speed interface) for connecting components. The various components are interconnected using different buses and may be mounted on a common mainboard or otherwise as desired. The processor may process instructions executed in the electronic device, including instructions stored in the memory or on the memory to display graphical information on graphical user interface (GUI) on an external input/output device, such as a display coupled to the interface. In other embodiments, a plurality of processors and/or a plurality of buses may be used with a plurality of memories. Further, a plurality of electronic devices may be connected, each device provides some of basic operations (e.g., as a server array, a set of blade servers, or a multi-processor system). For example, FIG. 5 shows one processor 501.

The memory 502 is a non-transitory computer-readable storage medium provided by the present disclosure. The memory stores instructions executable by at least one processor to cause the at least one processor to perform the method for training the face recognition model provided by the present disclosure. The non-transitory computer readable storage medium of the present disclosure stores computer instructions for causing a computer to perform the method for training the face recognition model provided by the present disclosure.

The memory 502 serves as anon-transitory computer-readable storage medium for storing a non-transitory software program, a non-transitory computer-executable program and module, such as program instructions/modules (e.g., the acquiring module 410, the generating module 420 and the training module 430 shown in FIG. 4) corresponding to the method for training the face recognition model in the embodiments of the present disclosure. The processor 501 executes non-transient software programs, instructions and modules stored in the memory 502 to perform various functional applications of the server and to process data, that is, to perform the method for training the face recognition model in the above-described method embodiments.

The memory 502 may include a program storage area and a data storage area. The program storage area may store an operating system and an application program required by at least one function, and the storage data area may store data or the like created according to the use of the electronic device. In addition, memory 502 may include high speed random access memory and may also include non-transitory memory, such as at least one magnetic disk storage device, flash memory device, or other non-transitory solid state storage device. In some embodiments, the memory 502 may optionally include memory remotely located with respect to the processor 501, which may be communicated with the electronic device via a network. Examples of such networks include, but are not limited to, the Internet, intranets, local area networks, mobile communication networks, and combinations thereof.

The electronic device may further include: an input device 503 and an output device 504. The processor 501, the memory 502, the input device 503 and the output device 504 may be connected via a bus or other manners. For example, FIG. 5 shows the connection by the bus.

The input device 503 may receive input numeric or character information and generate signal inputs related to user settings and functional controls of the electronic device. For example, the input device may be a touch screen, a keypad, a mouse, a track pad, a touch pad, a pointing stick, one or more mouse buttons, a track ball or a joystick. The output device 504 may be a display device, an auxiliary lighting device (e.g., LED), a tactile feedback device (e.g., a vibration motor), etc. The display device may include, but is not limited to, a liquid crystal display (LCD), a light emitting diode (LED) display, and a plasma display. In some embodiments, the display device may be a touch screen.

Various embodiments of the systems and techniques described here may be implemented in a digital electronic circuitry, an integrated circuit system, an application specific integrated circuit (ASIC), a computer hardware, a firmware, a software, and/or combinations thereof. These various embodiments may be implemented in one or more computer programs, or by the one or more computer programs that are executed and/or interpreted on a programmable system including at least one programmable processor (such as a dedicated or general purpose programmable processor) that can receive data and instructions from, and transmit data and instructions to, a storage system, at least one input device, and at least one output device.

These computing programs (also referred to as programs, software, software applications, or codes) include machine instructions for the programmable processor, and may be implemented by using high-level procedural and/or object-oriented programming languages, and/or assembly/machine languages. As used herein, the term “machine-readable medium” or “computer-readable medium” refers to any computer program product, apparatus and/or device (e.g., a magnetic disk, an optical disk, a memory, a programmable logic device (PLD)) for providing machine instructions and/or data to the programmable processor, which includes a machine-readable medium that receives the machine instruction as a machine-readable signal. The term “machine-readable signal” refers to any signal used to provide machine instructions and/or data to the programmable processor.

In order to provide interaction with a user, the systems and techniques described herein may be implemented on a computer having a display device (e.g., a cathode ray tube (CRT) monitor or a liquid crystal display (LCD) monitor) for displaying information to a user; and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and Block-chain network.

The computer system may include a client and a server. The client and server are generally remote from each other and interacting through a communication network. The client-server relation is generated by computer programs running on the respective computers and having a client-server relation with each other. The server can be a cloud server, also known as a cloud computing server or a cloud host, which is a host product in the cloud computing service system, to solve the traditional physical host with a virtual private server (VPS) service, which has the defects of difficult management and weak business expansibility. The server can also be a server for a distributed system, or a server that incorporates a block-chain.

According to the technical solutions of the embodiments of the present disclosure, the face recognition model is trained by using the plurality of uncovered face images and the plurality of second training images acquired by fusing the plurality of covering objects into each uncovered face image. The trained face recognition model can accurately identify both uncovered face images and covered face images, which solves the technical problem of the low accuracy or even the inability in recognizing face images in which the face of the images is partially covered by an object in the existing face recognition models.

It should be understood that for the various forms of processes shown above, operations may be reordered, added or deleted. For example, the operations described in the present disclosure could be performed in parallel, sequentially, or in a different order, as long as the desired result of the technical solution disclosed in the present disclosure is achieved.

The above specific embodiments do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A method for training a face recognition model, comprising:
acquiring a plurality of first training images being uncovered face images, and acquiring a plurality of covering object images;
generating a plurality of second training images by separately fusing the plurality of covering object images with the uncovered face images; and
training the face recognition model by inputting the plurality of first training images and the plurality of second training images into the face recognition model.

2. The method of claim 1, wherein acquiring the plurality of covering object images comprises:
acquiring a plurality of covered face sample images, wherein each covered face sample image is marked with a boundary coordinate of a covering region where at least a part of a face of the covered face sample image is covered by a covering object;
acquiring boundary coordinates of covering regions of the plurality of covered face sample images; and
extracting the plurality of covering object images from the plurality of covered face sample images according to the boundary coordinates of the covering regions, respectively.

3. The method of claim 2, wherein each covered face sample image is further marked with a face feature point, and generating the plurality of second training images by separately fusing the plurality of covering object images with the uncovered face images comprises:
acquiring a face feature point of a corresponding position in each covering object image, wherein the corresponding position refers to a position where a covering object of the covering object image is to be positioned on a face, and dividing each covering object image into a plurality of first triangular regions according to the face feature point of the corresponding position in each covering object image;
acquiring a feature point of each uncovered face image, and dividing each uncovered face image into a plurality of second triangular regions according to the feature point of the uncovered face image;
acquiring a mapping relationship between the plurality of first triangular regions and the plurality of second triangular regions;
performing affine mapping on each covering object image to the uncovered face images according to the mapping relationship to acquire first candidate covered face images; and
generating the plurality of second training images according to the first candidate covered face images.

4. The method of claim 3, wherein generating the plurality of second training images according to the first candidate covered face images comprises:
performing affine mapping on the boundary coordinates of the covering regions to a coordinate of the uncovered face image to acquire coordinates of second candidate covered face images;
removing, according to the coordinates of the second candidate covered face images, an uncovered region from the first candidate covered face images to acquire mapped covering object images; and
fusing the mapped covering object images with the uncovered face image to acquire the plurality of second training images.

5. The method of claim 1, wherein the face recognition model comprises:
a feature extraction network configured to acquire a feature map of a face image according to a preset feature extraction weight; and
a recognition module configured to acquire a comparison result by comparing the feature map of the face image with a preset feature map stored in a model library, and to determine a face recognition result according to the comparison result.

6. The method of claim 1, wherein the number of the plurality of first training images and the number of the plurality of second training images input to the face recognition model are of a same order of magnitude.

7. The method of claim 4, wherein the mapped covering object images is fused with the uncovered face image to form a fused boundary, and the method further comprises:
performing a smoothing process on the fused boundary.

8. A face recognition method, comprising:
acquiring a face image to be recognized; and
inputting the face image to be recognized into a face recognition model to acquire a recognition result output by the face recognition model, wherein the face recognition model is trained by a method for training the face recognition model comprising:
acquiring a plurality of first training images being uncovered face images, and acquiring a plurality of covering object images;
generating a plurality of second training images by separately fusing the plurality of covering object images with the uncovered face images; and
training the face recognition model by inputting the plurality of first training images and the plurality of second training images into the face recognition model.

9. The face recognition method of claim 8, wherein acquiring the plurality of covering object images comprises:
acquiring a plurality of covered face sample images, wherein each covered face sample image is marked with a boundary coordinate of a covering region where at least a part of a face of the covered face sample image is covered by a covering object;
acquiring boundary coordinates of covering regions of the plurality of covered face sample images; and
extracting the plurality of covering object images from the plurality of covered face sample images according to the boundary coordinates of the covering regions, respectively.

10. The face recognition method of claim 9, wherein each covered face sample image is further marked with a face feature point, and generating the plurality of second training images by separately fusing the plurality of covering object images with the uncovered face images comprises:
acquiring a face feature point of a corresponding position in each covering object image, wherein the corresponding position refers to a position where a covering object of the covering object image is to be positioned on a face, and dividing each covering object image into a plurality of first triangular regions according to the face feature point of the corresponding position in each covering object image;
acquiring a feature point of each uncovered face image, and dividing each uncovered face image into a plurality of second triangular regions according to the feature point of the uncovered face image;
acquiring a mapping relationship between the plurality of first triangular regions and the plurality of second triangular regions;
performing affine mapping on each covering object image to the uncovered face images according to the mapping relationship to acquire first candidate covered face images; and
generating the plurality of second training images according to the first candidate covered face images.

11. The face recognition method of claim 10, wherein generating the plurality of second training images according to the first candidate covered face images comprises:
performing affine mapping on the boundary coordinates of the covering regions to a coordinate of the uncovered face image to acquire coordinates of second candidate covered face images;
removing, according to the coordinates of the second candidate covered face images, an uncovered region from the first candidate covered face images to acquire mapped covering object images; and
fusing the mapped covering object images with the uncovered face image to acquire the plurality of second training images.

12. The face recognition method of claim 8, wherein the face recognition model comprises:
a feature extraction network configured to acquire a feature map of a face image according to a preset feature extraction weight; and
a recognition module configured to acquire a comparison result by comparing the feature map of the face image with a preset feature map stored in a model library, and to determine a face recognition result according to the comparison result.

13. The face recognition method of claim 8, wherein the number of the plurality of first training images and the number of the plurality of second training images input to the face recognition model are of a same order of magnitude.

14. The face recognition method of claim 8, wherein the mapped covering object images is fused with the uncovered face image to form a fused boundary, and the method for training the face recognition model further comprises:
performing a smoothing process on the fused boundary.

15. An electronic device, comprising:
at least one processor; and
a memory communicatively connected with the at least one processor;
wherein the memory stores instructions executable by the at least one processor, and when the instructions are executed by the at least one processor, the at least one processor is configured to implement a method for training a face recognition model, the method comprising:
acquiring a plurality of first training images being uncovered face images, and acquiring a plurality of covering object images;
generating a plurality of second training images by separately fusing the plurality of covering object images with the uncovered face images; and
training the face recognition model by inputting the plurality of first training images and the plurality of second training images into the face recognition model.

16. The electronic device of claim 15, wherein acquiring the plurality of covering object images comprises:
acquiring a plurality of covered face sample images, wherein each covered face sample image is marked with a boundary coordinate of a covering region where at least a part of a face of the covered face sample image is covered by a covering object;
acquiring boundary coordinates of covering regions of the plurality of covered face sample images; and
extracting the plurality of covering object images from the plurality of covered face sample images according to the boundary coordinates of the covering regions, respectively.

17. The electronic device of claim 16, wherein each covered face sample image is further marked with a face feature point, and generating the plurality of second training images by separately fusing the plurality of covering object images with the uncovered face images comprises:
acquiring a face feature point of a corresponding position in each covering object image, wherein the corresponding position refers to a position where a covering obj ect of the covering object image is to be positioned on a face, and dividing each covering object image into a plurality of first triangular regions according to the face feature point of the corresponding position in each covering object image;
acquiring a feature point of each uncovered face image, and dividing each uncovered face image into a plurality of second triangular regions according to the feature point of the uncovered face image;
acquiring a mapping relationship between the plurality of first triangular regions and the plurality of second triangular regions;
performing affine mapping on each covering object image to the uncovered face images according to the mapping relationship to acquire first candidate covered face images; and
generating the plurality of second training images according to the first candidate covered face images.

18. The electronic device of claim 17, wherein generating the plurality of second training images according to the first candidate covered face images comprises:
performing affine mapping on the boundary coordinates of the covering regions to a coordinate of the uncovered face image to acquire coordinates of second candidate covered face images;
removing, according to the coordinates of the second candidate covered face images, an uncovered region from the first candidate covered face images to acquire mapped covering object images; and
fusing the mapped covering object images with the uncovered face image to acquire the plurality of second training images.

19. The electronic device of claim 15, wherein the face recognition model comprises:
a feature extraction network configured to acquire a feature map of a face image according to a preset feature extraction weight; and
a recognition module configured to acquire a comparison result by comparing the feature map of the face image with a preset feature map stored in a model library, and to determine a face recognition result according to the comparison result.

20. The electronic device of claim 15, wherein the number of the plurality of first training images and the number of the plurality of second training images input to the face recognition model are of a same order of magnitude.
